(19) United States
(12) Patent Application Publication
(10) Pub. No.: US 2016/0025199 A1
(43) Pub. Date: Jan. 28, 2016

(54) BALL SCREW ACTUATOR WITH INTERNAL LOCKING

(71) Applicant: Triumph Actuation Systems - Connecticut, LLC, d/b/a Triumph Aerospace Systems - Seattle, Redmond, WA (US)

(72) Inventors: Nicholas Andrew Boone, Coeur d'Alene, ID (US); Gordon J. Francis, Issaquah, WA (US)

(21) Appl. No.: 14/806,185

(22) Filed: Jul. 22, 2015

Related U.S. Application Data
(60) Provisional application No. 62/028,881, filed on Jul. 25, 2014.

(51) Int. Cl. F16H 25/22; F16H 25/24

(52) U.S. Cl. CPC F16H 25/2204; F16H 25/2454; F16H 2025/2071

(57) ABSTRACT

A screw actuator may comprise: a barrel; a piston rod movable in the barrel in an extending direction and in a retracting direction; an elongated screw in the bore of the barrel and rotatable by a motor drive; a nut coupled to the piston rod and movable in the bore of the barrel in the extending direction and in the retracting direction responsive to rotation of the elongated screw; and a plurality of lock segments in the piston rod and movable radially outward and radially inward in response to movement of the nut. The plurality of lock segments engage the barrel when moved radially outward and do not engage the barrel when moved radially inward, whereby the piston rod is lockable to the barrel by the plurality of lock segments for bearing loads applied thereto.

This application claims the benefit of the priority of U.S. Provisional Patent Application No. 62/028,881 entitled “BALL SCREW ACTUATOR WITH INTERNAL LOCKING” filed on Jul. 25, 2014, which is hereby incorporated herein by reference in its entirety.

The present invention relates to an actuator and, in particular, to a screw actuator with internal locking.

Linear ball screw actuators are employed in various environments and applications for moving one mechanical part relative to another mechanical part. Ball screw actuators may be powered by a hydraulic motor drive or by an electric motor drive. One example application is for aircraft wherein actuators may be employed to deploy and retract various assemblies, e.g., a landing gear, a cargo door, a foldable part such as part of a wing, blade or tail, and other similar parts. Ball screw actuators employed to deploy and retract landing gear, which in addition may act as landing gear side or drag braces, must withstand substantial structural loads, e.g., landing loads and ground loads, in addition to actuation loads.

Current conventional actuators are held in a particular position, e.g., extended, by the ball screw and gear box mechanism which bears the structural loads which can be substantially larger than the actuation loads for deploying and retracting the actuator. In such case, the drive mechanism must be made substantially stronger so that it can bear the structural loads. As a result the actuator and its drive mechanism can be quite heavy.

Applicant believes there may be a need for a ball screw actuator that has an internal locking arrangement so that the mechanical screw drive need only bear the actuating loads.

Accordingly, a screw actuator may comprise: a barrel; a piston rod movable in the barrel in an extending direction and in a retracting direction; an elongated screw in the bore of the barrel and rotatable by a motor drive; a nut coupled to the piston rod and movable in the bore of the barrel in the extending direction and in the retracting direction responsive to rotation of the elongated screw; and a plurality of lock segments in the piston rod and movable radially outward and radially inward in response to movement of the nut. The plurality of lock segments engage the barrel when moved radially outward, whereby the piston rod is lockable to the barrel by the plurality of lock segments for bearing loads applied thereto.

Accordingly, a screw actuator may comprise: a barrel; a piston rod movable in the barrel in an extending direction and in a retracting direction; a ball screw in the bore of the barrel and rotatable by a motor drive; a ball nut coupled to the piston rod and movable in the bore of the barrel in the extending direction and in the retracting direction responsive to rotation of the ball screw; and a plurality of lock segments in the piston rod and movable radially outward and radially inward in response to movement of the ball nut. The plurality of lock segments engage the barrel when moved radially outward, whereby the piston rod is lockable to the barrel by the plurality of lock segments for bearing loads applied thereto.

In summarizing the arrangements described and/or claimed herein, a selection of concepts and/or elements and/or steps that are described in the detailed description herein may be made or simplified. Any summary is not intended to identify key features, elements and/or steps, or essential features, elements and/or steps, relating to the claimed subject matter, and so are not intended to be limiting and should not be construed to be limiting of or defining of the scope and breadth of the claimed subject matter.

### BRIEF DESCRIPTION OF THE DRAWING

The detailed description of the preferred embodiment(s) will be more easily and better understood when read in conjunction with the FIGURES of the Drawing which include:

FIGS. 1A and 1B are perspective views of example embodiments of an actuator viewed from opposite ends thereof;

FIGS. 2A and 2B are a side view and a side cross-sectional view 2B-2B, respectively, of the example actuator of FIG. 1;

FIGS. 3A and 3B are an end view and a cut-away end view, respectively, of the drive end of the example actuator of FIGS. 1A and 1B, and FIG. 3C is an end view of the opposite end thereof;

FIGS. 4A and 4B are side cross-sectional views of the example actuator in an extended and locked position and in a retracted and unlocked position, respectively;

FIG. 5 is an enlarged side cross-sectional view of the locking mechanism of the example actuator illustrating the locking mechanism in an engaged (locked) position;

FIGS. 6A, 6B and 6C are side cross-sectional views of the locking mechanism of the example actuator in an extended and locked position, in a position with its lock segments partially engaged and in a position with the piston near full extension with its lock fully disengaged, respectively;

FIG. 7 is an enlarged side cross-sectional view of the locking mechanism of an alternative embodiment of an example actuator illustrating the locking mechanism in an engaged (locked) position;

FIGS. 8A, 8B and 8C are side cross-sectional views of the locking mechanism of the alternative example actuator in an extended and locked position, in a position with its lock segments partially engaged and in a position with the piston neat full extension with its lock fully disengaged, respectively;

FIG. 9A is a perspective view of the head end of an embodiment of the example actuator including one or more pressure ports therein, and FIGS. 9B-9D are cross-sectional views thereof illustrating operation of the one or more pressure ports to disengage the motor drive and to move the piston rod axially to the extended position; and

FIG. 10 is aside cross-sectional view of an example embodiment of an actuator including passive damping.

In the Drawing, where an element or feature is shown in more than one drawing figure, the same alphanumeric designation may be used to designate such element or feature in each figure, and where a closely related or modified element is shown in a figure, the same alphanumerical designation primed or designated “a” or “b” or the like may be used to designate the modified element or feature. Similarly, similar elements or features may be designated by like alphanumeric designations in different figures of the Drawing and with similar nomenclature in the specification. According to common practice, the various features of the drawing are not to scale, and the dimensions of the various features may be arbitrarily expanded or reduced for clarity, and any value stated in any Figure is given by way of example only.

### DESCRIPTION OF THE PREFERRED EMBODIMENT(S)

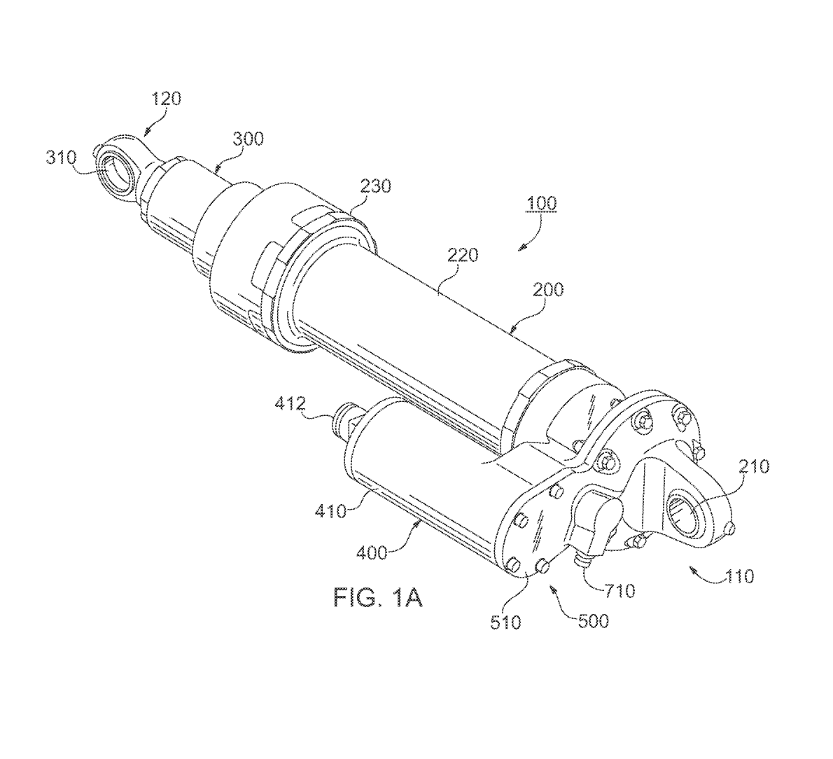

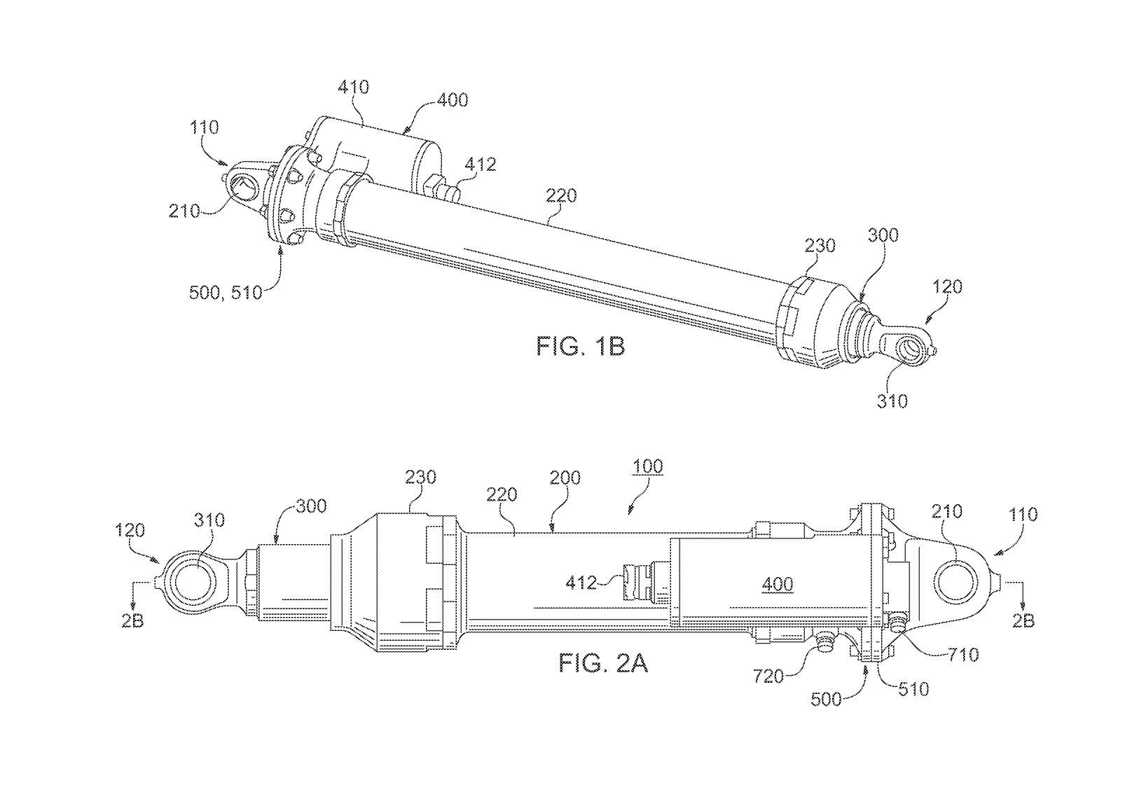

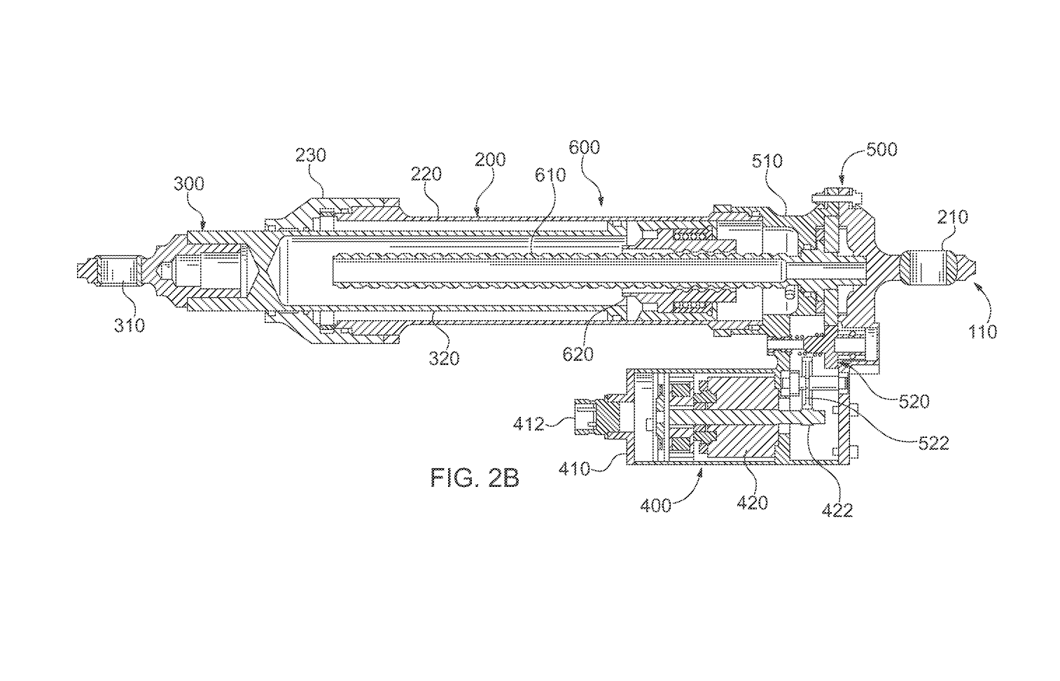

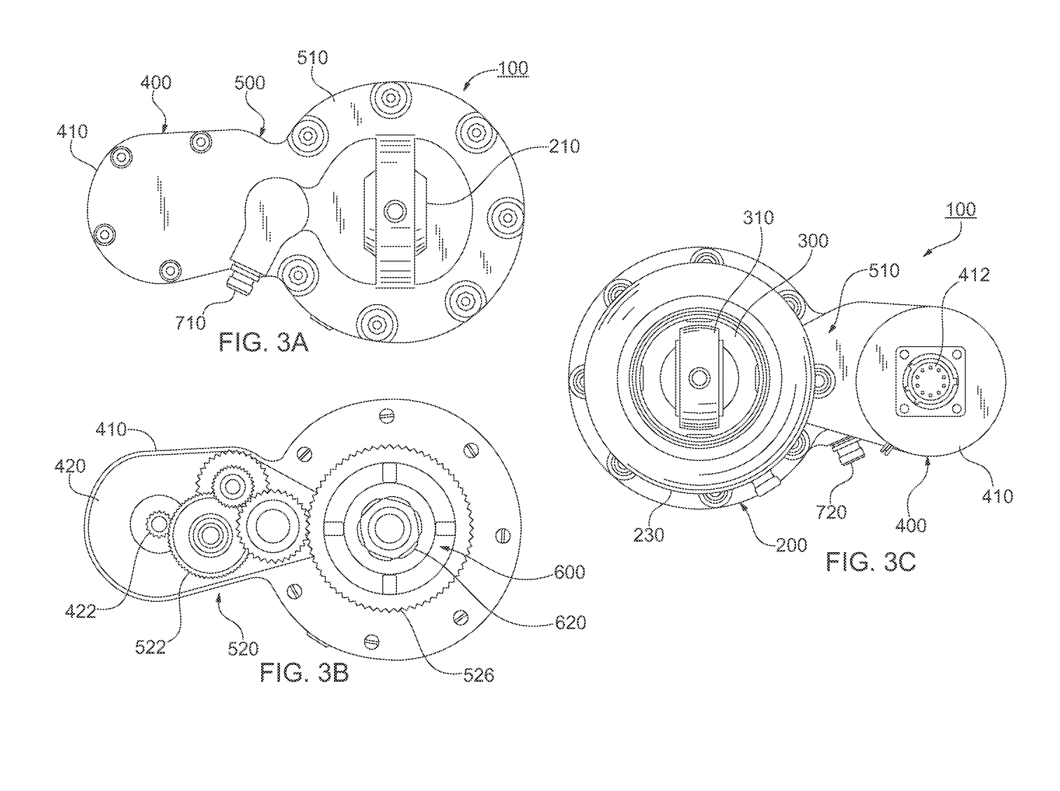

FIGS. 1A and 1B are perspective views of example embodiments of an actuator 100 viewed from opposite ends thereof; FIGS. 2A and 2B are a side view and a side cross-sectional view 2B-2B, respectively, of the example actuator 100 of FIG. 1; FIGS. 3A and 3B are an end view and a cut-away end view (e.g., with the gear housing 510 cover removed), respectively, of the drive or head end 110 of the example actuator 100 of FIGS. 1A and 1B, and FIG. 3C is an end view of the opposite end 120 thereof which may also be referred to as the free end or the or rod end thereof.

Actuator 100 includes a cylinder barrel 200 having a barrel tube 220 supporting a head end lug 210 at the head end 110 thereof and a piston rod end gland fitting 230 at the rod end thereof. Piston rod 300 is disposed in cylinder barrel 200 and is movable longitudinally within cylinder barrel 200, and has a rod end lug 310 at the end thereof, e.g., that is threaded onto the end of piston rod tube 320. Piston rod 300 is moved or driven outward from cylinder barrel 200 and is moved or driven inward into cylinder barrel 200 for actuator 100 to extend and to retract, respectively. Typically, head end lug 110 is attached to a fixed structure, e.g., to an airframe or a part thereof, by a fastener, e.g., typically by a bolt, and rod end lug 210 is attached to a movable structure, e.g., to a landing gear part or a wing part or a door, by a fastener, e.g., typically by a bolt.

Extension and retraction of actuator 100 is provided by a drive arrangement 400, 500 including a drive motor assembly 400 and a gear assembly 500 which are mounted at the head end of actuator 100. Drive assembly 400 includes a housing 410 in which is disposed an motor 420, which may be an electric motor 420 as illustrated or may be a hydraulic motor 420. A motor, 420, e.g., an electric motor 420, is operated responsive to electrical power and/or control signals applied via electrical connector 412 in the end of motor housing 410, and a hydraulic motor 420 is operated responsive to the flow of hydraulic fluid applied under pressure via hydraulic ports 412 of hydraulic motor 420. Electrical connector 412 and/or hydraulic ports 412 may be located on motor housing 410 in any suitable location, e.g., in a substantially similar location as illustrated for connector 412.

The resulting rotation of output shaft 422 of drive motor 420 is coupled to a screw assembly 600, e.g., a ball screw assembly 600, within barrel tube 220 of cylinder barrel 210 via a gear assembly 500 including a gear train 520 residing within gear housing 510 that couples drive motor 420 to the ball screw assembly 600. Screw assembly 600 includes an elongated screw 610, e.g., a ball screw 610, and a compatible nut 620, e.g., a ball nut 620 riding thereon and coupled thereto by thread engagement, e.g., by bearing balls (not visible) that run in the external helical groove or grooves of ball screw 610 and in a circumferential groove or sockets in the interior cylindrical surface of ball nut 620 adjacent to ball screw 610, so that rotation of ball screw 610 produces translation of ball nut 620 on ball screw 610.

Bearing balls which here need only bear actuation loads are like ball bearings, i.e. the load-bearing balls employed in ball bearing assemblies which often include a race or retainer for retaining the balls; here the helical grooves of ball screw 610 and the complementary grooves or seats of ball nut 620 or another retainer member retain the bearing balls (ball bearings) in their proper position. It is noted that operating loads between end lugs 210, 310 are borne by barrel 200 and piston rod 300 when engaged and locked by locking mechanism 800, and not by ball screw 610 and ball nut 620 of screw assembly 600, thereby reducing the load to be borne by screw assembly 600, gear train 520 and motor 420 and enabling the size and weight thereof to be reduced.

Because locking mechanism 800 engages to provide a direct load bearing path between actuator barrel 200 and piston rod 300, any load applied to lugs 210, 310 is carried by the actuator structure 200, 300, 800, which typically is substantial, and not by the drive components 400, 400, 600, which are more complex and can be more fragile. Thus, drive components 400, 500, 600 are isolated from the stress of loads by the internal locking mechanism 800.

Gear train 520 resides in gear housing 510, which is also a head end cap 510 of barrel 300, and typically includes one or more stages of reduction gears between the output shaft 422 of drive motor 420 and ball screw assembly 600. Gear train 520 may employ any suitable complement of gears 520, e.g., one or more of spur gears, idler gears and the like on various axles, spindles and other supports. For example, a first spur gear 522 may engage a spur gear of output shaft 422 of drive motor 420 and a final spur gear 526 may engage ball screw 610.

Operating drive motor 420 to produce rotation of output shaft 422 thereof in a first direction causes ball nut 620 riding on ball screw 610 to move axially in a direction of translation away from head end 110 thereby to drive piston 300 outward from cylinder barrel 200 and to extend actuator 100. Operating drive motor 420 to produce rotation of shaft 422 thereof in a second and opposite direction causes ball nut 620 riding on ball screw 610 to move axially in a direction of translation towards head end 110 thereby to drive piston 300 inward into cylinder barrel 200 and to retract actuator 100. Drive motor assembly 400 and gear assembly 500 may be referred to herein as a drive motor or as a motor drive or as a drive arrangement.

Actuator 100 may optionally, but in some instances preferably, include a “blow down” mechanism 700 whereby fluid pressure, e.g., by a gas such as air or nitrogen or by a liquid such as hydraulic fluid, may be applied to extend actuator 100 in the unlikely circumstance wherein drive motor assembly 400 is unable to extend actuator 100. To that end, a first pneumatic or hydraulic port 710 may be provided to apply fluid pressure to disengage gear train 520 so that drive motor 420 is mechanically disconnected or disengaged from ball screw assembly 600 so that ball screw 610 and ball nut 620 can free wheel. A second pneumatic or hydraulic port 720 is provided to apply fluid pressure to the head end of piston 300 so that piston rod 300 moves axially to extend actuator 100. Blow down mechanism 700 is described herein below.

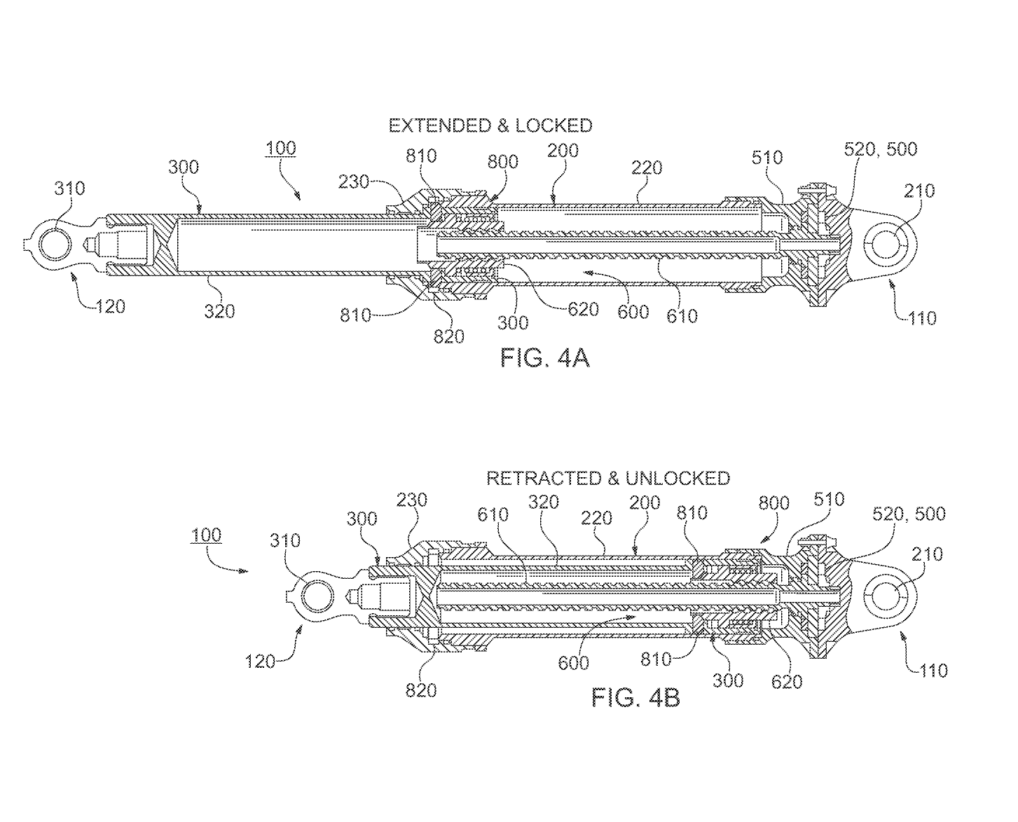

FIGS. 4A and 4B are side cross-sectional views of the example actuator 100 in an extended and locked position and in a retracted and unlocked position, respectively. Therein, in the retracted position, piston rod 300 is disposed inside of barrel tube 220 of cylinder barrel 200 (or barrel 200) with ball screw 610 inside of piston rod 300 and ball screw nut 620 being drawn substantially to the head end 120 thereof. In this position, actuator 100 is fully retracted and unlocked and the distance between head end lug 210 and rod end lug 310 is at its operating minimum.

Thereat, locking mechanism 800 is unlocked with the plural lock segments 810 thereof in a radially inward position whereat they are free to move longitudinally (axially) proximate the interior surface of barrel tube 220 of barrel 200 with ball nut 620 and piston rod 300. In this retracted position, actuator 100 in use typically does not bear any substantial structural load and so the retracted position may be maintained by a power off brake or clutch mechanism that is coupled to ball screw assembly 600 and gear train 500.

Actuator 100 is driven from the retracted position to the extended position by operating drive motor assembly 400 and gear train 520 to rotate ball screw 610 in a direction to drive ball screw nut 620 in a direction from head end 110 towards rod end 120, thereby to drive piston rod 300 to which ball nut 620 is connected towards rod end 120. Similarly, actuator 100 is driven from the extended position to the retracted position by operating electric drive motor assembly and gear train 520 to rotate ball screw 610 in an opposite direction to drive ball screw nut 620 in a direction from rod end 120 towards head end 110, thereby to drive piston rod 300 to which ball nut 620 is connected towards head end 110.

In the extended position, actuator 100 can support a substantial structural load, e.g., functioning as a structural brace, to maintain a deployed structure, e.g., a landing gear or wing part, in its operational position. Because a power off brake, e.g., ball screw assembly 600 and drive elements 400, 500, are not sized to support such structural load, actuator 100 includes a locking mechanism 800 that locks the piston rod 300 in its extended position relative to barrel 200 so that structural loads are entirely supported by barrel 200 and piston rod 300 which are structurally locked together by locking mechanism 800.

While ball screw assembly 600 and its drive elements 400, 500 could be sized to support the structural loads, such is considered undesirable because the additional weight and size that would be required for ball screw assembly 600 and its drive elements 400, 500, would render the actuator too large and too heavy to be advantageous. The described locking mechanism advantageously avoids such unnecessary bulk because ball screw assembly 600 and its drive elements 400, 500 can be sized to drive piston rod 300 under its actuation load which is typically much smaller than is the structural load.

In the extended and locked position, a substantial portion of piston rod 300 extends beyond the end of barrel 200, e.g., beyond rod end gland fitting 230 thereof, whereat the distance between head end lug 210 and rod end lug 310 is at its operating maximum. Only the head end of piston rod 300 remains inside of barrel 200, along with ball nut 320 which is substantially at the rod end of ball screw 610. In this extended position, ball nut 620 is driven into an over-travel position wherein locking mechanism 800 locks piston rod tube 320 to barrel 200 with the plural lock segments 810 of locking mechanism 800 having been driven radially outward to engage into openings (receptacles) therefor in the wall of barrel tube 220 of barrel 200.

Once actuator 100 is extended and locked, operation loads, whether in tension or in compression, are transferred through the structure 200, 300, 800 of actuator 100 and not through the drive elements 400, 500, 600 thereof. When actuating power is not applied to the drive train 400, 500, 600, a lock spring maintains ball nut 620 and plural lock segments 810 in their locked positions.

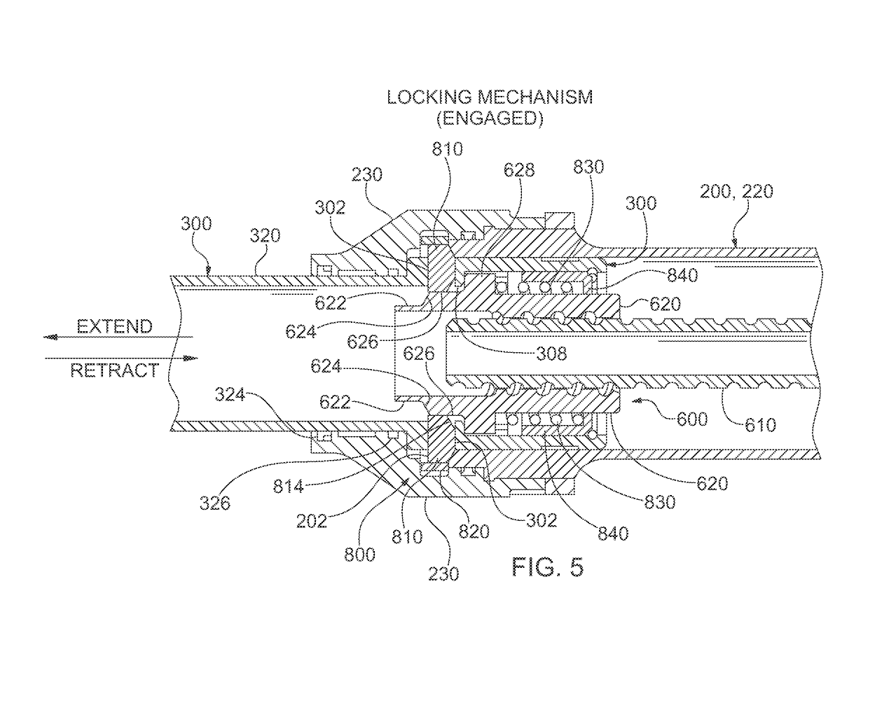

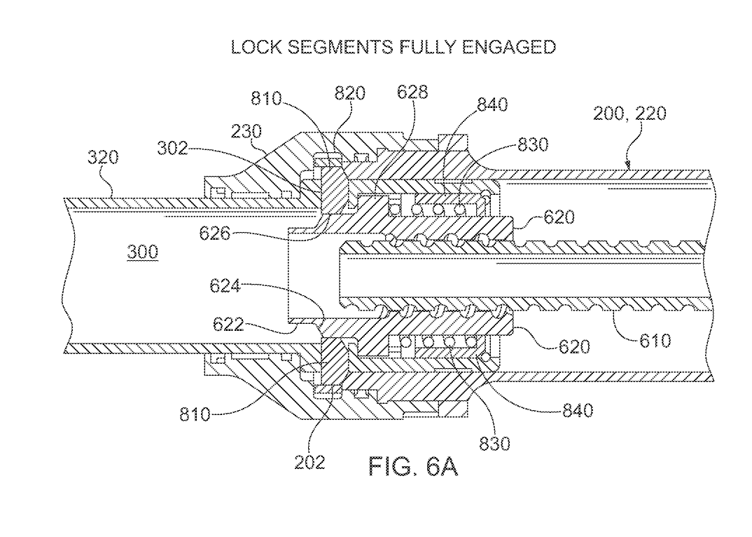

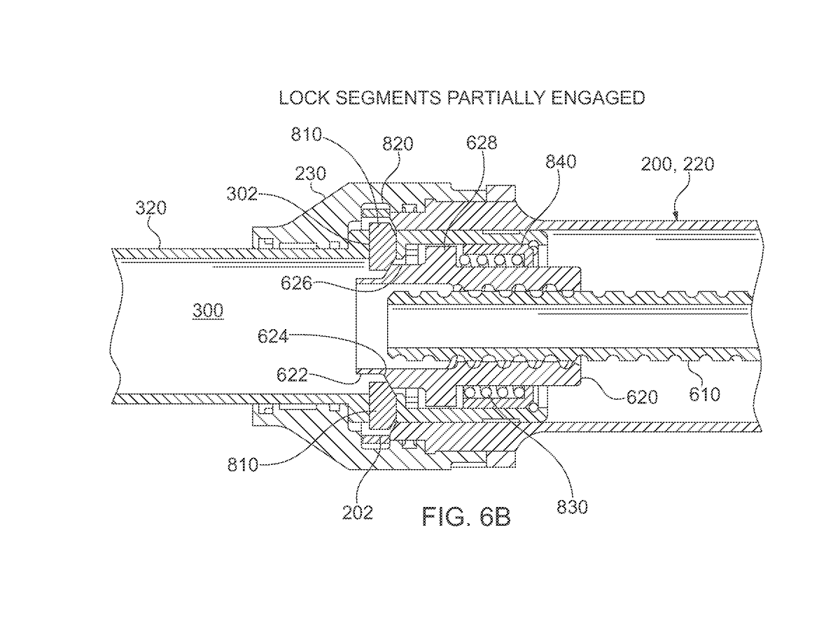

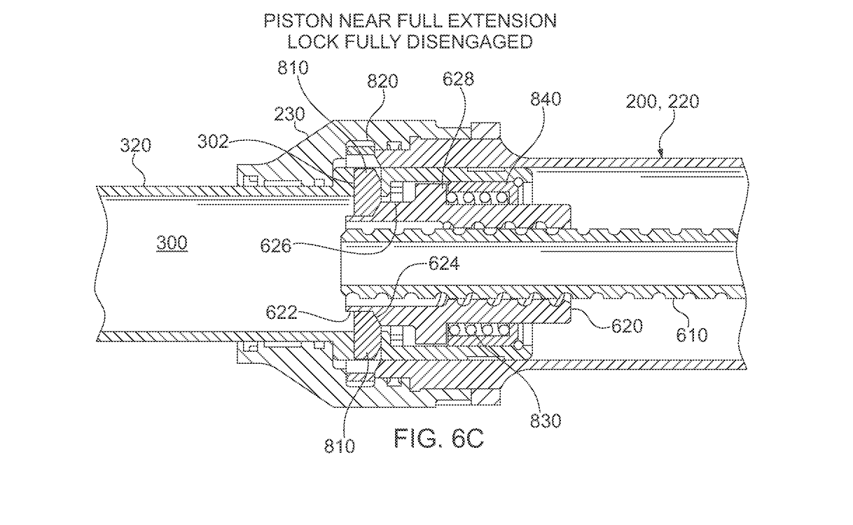

FIG. 5 is an enlarged side cross-sectional view of the locking mechanism 800 of the example actuator 100 illustrating the locking mechanism 800 in an engaged (locked) position; and FIGS. 6A, 6B and 6C are side cross-sectional views of the locking mechanism 800 of the example actuator 100 in an extended and locked position, in a position with its lock segments 810 partially engaged and in a position with the piston 300 near full extension with its lock mechanism 800 fully disengaged, respectively.

In the locked position of locking mechanism 800, plural lock segments 810 have been driven radially outward in receptacles (openings) 302 in piston rod 300, thereby to lock the structure of piston rod 300 to the structure of barrel 200 and carry any structural loads applied to actuator 100. In this position, the inner ends of lock segments 810 are adjacent a cylindrical surface 626 (or at least a cylindrical surface segment) or a flat surface of ball nut 620 that is of a given diameter selected to so position lock segments 810 a predetermined radial distance from a central axis of ball screw 610 and ball nut 620. It is noted that structural loads may include both static loads and/or dynamic loads.

As illustrated, lock segments 810 extend radially outward to engage the annular end of barrel 200 at the rod end thereof, and within rod end gland fitting 230 which is formed to provide a space or groove 202 at the rod end of barrel 200 into which lock segments 810 may be extended. Alternatively, receptacles or openings 302 may be positioned to align with a locking groove 202 in the interior wall of barrel 200 proximate the rod end thereof, e.g., in the interior surface of rod end gland fitting 230, whereby lock mechanism 800 can function irrespective of the relative angular positions of barrel 200 and piston rod 300. Thus, piston rod 300 may be rotated to any desired degree relative to barrel 200 without affecting operation of locking mechanism 800. Also alternatively, piston rod 300 may be angularly restricted so as to be in a predetermined angular position relative to barrel 200, in which case companion receptacles or openings 202 may be provided in the interior wall of barrel tube 220 and/or of rod end gland fitting 230, with which lock segments 810 of locking mechanism 800 may engage.

In this locked or engaged position, lock segments 810 bear against and urge lock indication ring 820 outwardly, e.g., in space 202, thereby to provide a positive indication that actuator 100 is indeed extended and locked in the extended position. Lock indication ring 820 may provide a visual indication that actuator 100 is indeed extended and locked in the extended position, e.g., by a split in ring 820 being visible and/or exposing a colored interior surface, and/or may provide a signal indication that actuator 100 is indeed extended and locked in the extended position, e.g., by actuating an electrical switch or other sensor mounted to actuator 100 to provide, e.g., a change of switch contact state, such as a switch closure.

Ball screw nut 620 (or ball nut 620) has a shaped outer surface for interfacing ball nut 620 with the interior of piston rod 300 and with lock segments 810. At the rod end thereof, ball nut 620 has a relatively smaller diameter substantially cylindrical surface 622 (or at least segments approximating a cylindrical surface 622) or has plural flat surfaces 626 adjacent a ramp surface or surfaces 624 which is adjacent a relatively larger diameter cylindrical surface 626 (or at least segments approximating a cylindrical surface 626) or plural flat surfaces 626. The combination of these surfaces 622, 624, 626 provides a cam for moving lock segments 810 radially inward and outward for engaging and disengaging lock segments 810 of lock mechanism 800.

Lock segments 810 each have a chamfer 814 on a radially inward corner thereof that rides radially inwardly towards surface 622 and radially outwardly towards surface 626 on ball nut ramp surface 624 when ball nut 620 is moving axially at the rod end of barrel 200 as lock segments 810 move radially in openings 302 and radially out of and into the space or cavity 202 defined between the end of barrel 200 and rod end gland filling 230. Typically, lock segments 810 each also have a chamfered surface on a radially outward end thereof that bears against the sloped annular end of barrel 200 when lock mechanism 800 is engaged (locked), and which provide force tending to urge lock segments 810 radially inward to aid in releasing lock mechanism 800. These chamfered surfaces may be generally flat or arched flat, and preferably correspond to the shape of the surfaces, e.g., surfaces 622, 624, 626, against which they bear.

Typically, the radially outward ends of lock segments 810 may have a rounded or curved surface that may correspond to the curved shape of the inner wall surface of barrel tube 22, e.g., the ends of lock segments 810 may be rounded at about the diameter of the bore of barrel 22. Also typically, the radially inward ends of lock segments 810 may be substantially flat or if the surfaces 622, 624, 626 are curved, the inward ends of lock segments 810 may be rounded at a different radius, e.g., at the radius of the surfaces 622, 624, 626 on which lock segments 810 are urged outwardly. Lock segments 810 are sized and shaped to move radially inwardly and outwardly in their corresponding bores 302 of piston rod 300 without inducing excessive or abnormal wear and/or are shaped to avoid excessive or abnormal wear. Typically, each lock segment 810 may be arcuate and have an arcuate length corresponding to a few degrees of arc radially at about the inner diameter of barrel 200, 220.

Ball nut 620 also has outwardly extending flange segments 628 or other anti-rotation projections 628 that are adjacent to inwardly extending flange segments 308 or other anti-rotation projections 308 of piston rod 300 for retaining ball nut 620 in a predetermined angular position relative to piston rod 320 and the corresponding plural lock segment grooves 302, thereby moving piston rod 300 axially into and out of barrel 200 as ball nut 620 is moved by ball screw 610 responsive to motor drive 400 whilst restricting rotation of ball nut 620 relative to piston rod 320. While direct contact between flanges 308, 628 serves to restrain ball nut 620 to move piston rod 300 out of barrel 200 and extend actuator 100, spring collar 840 is retained on ball nut 620 and is coupled to flange 628 by lock spring 830 which together move piston rod 300 into cylinder barrel 200 to release lock mechanism 800 and to retract actuator 100. Lock collar 840 is retained in ball nut 620, e.g., by a snap ring, one or more pins, a threaded gland, or other suitable retainer. Lock spring 830 therein serves to bias ball nut 620 towards the locked position, but is not required for actuation or normal locking retention.

In disengaging ball assembly 600 and lock mechanism 800 out of the locked position, ball screw 610 is rotated to move ball nut 620 to the right (towards head end 110 in the figures). As ball nut 620 is moved to the right, lock spring 830 and collar 840 urge piston rod 300 to move in the same direction as larger diameter surfaces 626 move out from under lock segments 810 which then ride radially inwardly on ramp surfaces 624 as ball nut 620 continues rightward movement until lock segments 810 have moved sufficiently in openings 302 to rest on smaller diameter surfaces 622 at which position they are disengaged (fully withdrawn) from receptacles (openings) 202, and piston 300 is released to move within cylinder barrel 200. Then, piston 300 is able to be moved substantially into cylinder barrel 200 to the retracted position.

Drive motor drive 400 and gear assembly 500 preferably include a clutch or other friction plate lock, preferably near the motor end of gear train 520, so that the ball screw assembly 600 tends to remain in the position to which it has been driven by ball screw 610 and motor drive assembly 400, 500 and does not move when drive power is not applied thereto. Alternatively, such clutch may be utilized to hold actuator 100 in an intermediate position between the fully extended and fully retracted positions, where it will have a lesser structural load holding capability that may be useful in certain applications.

In the opposite direction, in engaging ball assembly 600 and lock mechanism 800 into the locked position, ball screw 610 is rotated to move ball nut 620 to the left (towards rod end 120 in the figures). As ball nut 620 is moved to the left, lock segments 810 are adjacent to smaller diameter surfaces 622 at which position they are disengaged from barrel 200 (e.g., are fully drawn into receptacles (openings) 302 of piston rod 300) as piston rod 300 is extended out of barrel 200. When ball nut 620 reaches a position where lock segments 810 are no longer confined within the bore of barrel 200, lock segments 810 then are driven radially outwardly on ramp surfaces 624 as ball nut 620 continues leftward movement until lock segments 810 rest on larger diameter surfaces 626 at which position they are engaged (driven) into the cavity 202, preferably a circumferential cavity 202, defined between the rod end of barrel 200 and rod end gland fitting 230, and piston 300 is locked and not able to move axially within barrel 200. Then, piston 300 is structurally fixed with barrel 200 in the extended position, and bear the structural loads applied to actuator 100.

Any suitable alternative configuration of ball screw drive 600 and/or lock mechanism 800, e.g., of lock segments 810 and/or ball nut 620, may be employed to provide a similar load bearing connection through the cylinder barrel 200 and the piston rod 300, thereby bypassing the ball screw drive 600, 610, 620, whereby ball screw 610 and ball nut 620 need only to be designed to support relatively lower loads, e.g., actuation loads, and so may be substantially smaller and of lower weight. In one example alternative described herein, e.g., a slidable lock piston is employed for moving lock segments 810.

Preferably, one or more seals are provided where piston rod 300, 320 enters the rod end gland fitting 230 at the end of piston barrel 200, 220. Suitable seals may be retained in grooves in the interior surface of rod end gland fitting 230 and may include a scraper seal 24 intended to remove debris from the outer surface of piston rod 300, 320 and a dynamic hydraulic seal intended to block leakage of hydraulic fluid.

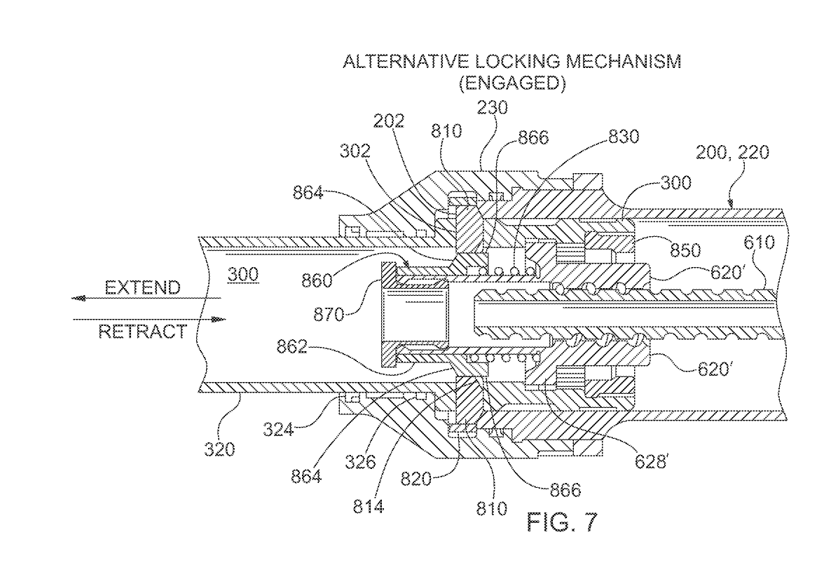

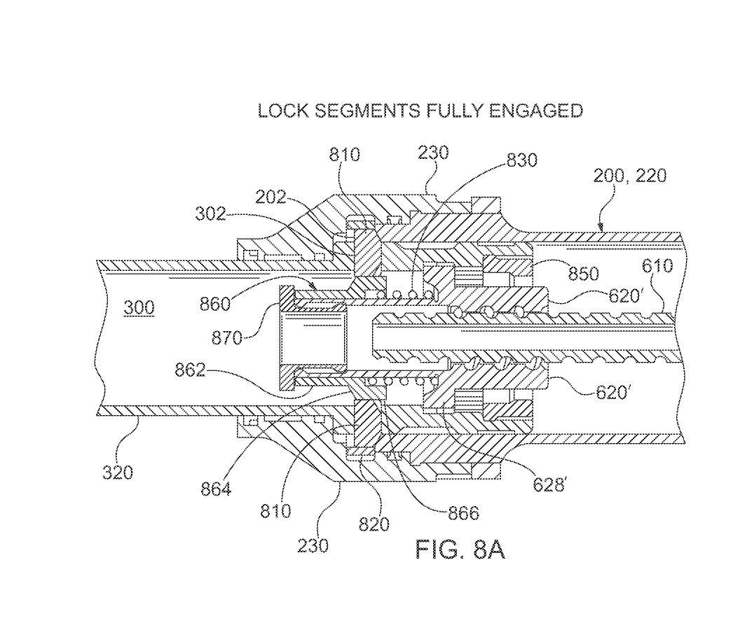

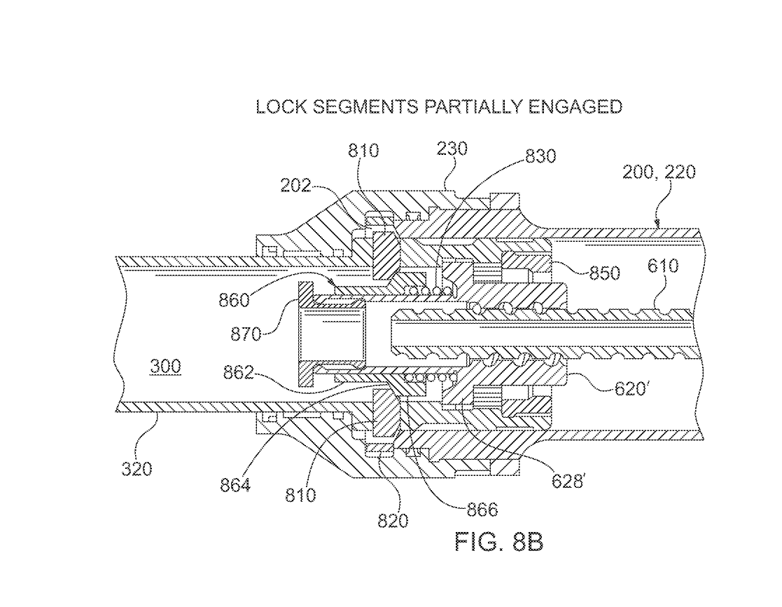

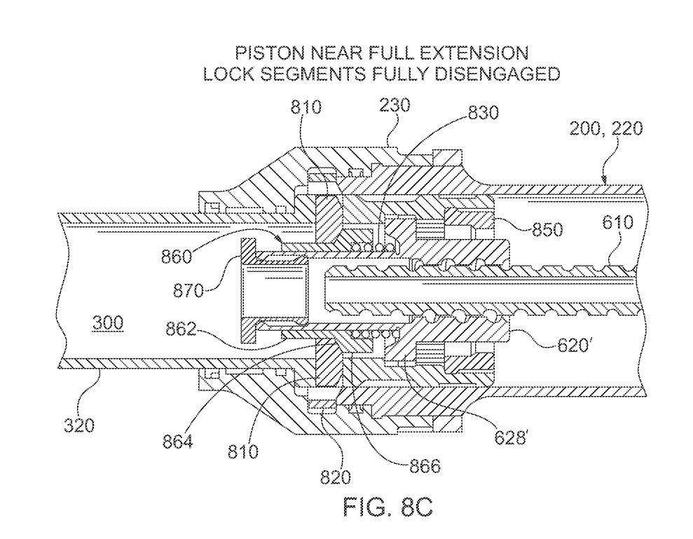

FIG. 7 is an enlarged side cross-sectional view of the locking mechanism 800 of than alternative embodiment of the example actuator 100 illustrating the locking mechanism 800 in an engaged (locked) position; and FIGS. 8A, 8B and 8C are side cross-sectional views of the locking mechanism 800′ of the example actuator 100 in an extended and locked position, in a position with its lock segments 810 partially engaged and in a position with the piston 300 near full extension with its lock mechanism 800 fully disengaged, respectively.

Actuator 100 of FIGS. 7-8C is substantially the same as actuator 100 described above, and operates in substantially the same manner thereto, except that ball nut 620′ of ball assembly 600 and certain of its related parts are differently configured. Instead of the surfaces 622, 624, 626 that move lock segments 810 radially outward and inward into and out of groove 202 of barrel 200 being provided by surfaces of ball nut 620′ they are provided by surfaces 862, 864, 866 of a lock piston 860 that is slidable axially on an axially cylindrical outer surface of ball nut 620′.

Lock piston 860 is urged towards the rod end of ball screw 620 by lock spring 830 and is retained on ball nut 620′ by lock piston stopper 870 which is affixed at the rod end of ball nut 620′. Because in locking lock mechanism 800 lock spring 830 is driven by ball nut 620′ which in turn drives lock piston 860 towards the lock position, the radially outward force applied to drive lock segments 810 into groove 202 is limited by spring 830 which tends to reduce wear, and can prevent excessive wear, on the interior (bore) surface of barrel 200.

Ball nut 620′ is retained in the head end of piston rod 300 by ball nut stop 850 which is affixed to piston rod 300 at the head end thereof. Axial movement of ball nut 620′ in the head end of piston rod 300 is limited by outwardly extending flange 628′ or anti-rotation projections 628′ which is or are captive between a shoulder on the interior surface of piston rod 300 and ball nut stop 850 affixed at the end thereof.

At the free or rod end thereof, lock piston 860 has a relatively smaller diameter substantially cylindrical surface 862 (or at least segments approximating a cylindrical surface 862) or flat surfaces 862 adjacent a ramp surface or surfaces 864 which is adjacent a relatively larger diameter cylindrical surface 866 (or at least segments approximating a cylindrical surface 866) or flat surfaces 866. As above, lock segments 810 each have a chamfer on a radially inward corner thereof that rides radially inwardly towards surface 862 and outwardly towards surface 866 on lock piston 860 ramp surface 864 when ball nut 620′ is moving axially at the rod end of barrel 200 as lock segments 810 move in openings 302 radially out of and into the cavity 202 between the rod end of barrel 200 and rod end gland fitting 230. The combination of these surfaces 862, 864, 866 provides a cam for engaging and disengaging lock segments 810 of lock mechanism 800.

Also as above, lock segments 810 each also have a chamfer 814 on a radially outward corner thereof that bears against the sloped annular end of barrel 200 when lock mechanism 800 is engaged (locked), and which provide force tending to urge lock segments 810 radially inward to aid in releasing lock mechanism 800. Both chamfers or rounded surfaces of lock segments 810 need not be, and typically are not, of the same size and shape.

In disengaging ball assembly 600 and lock mechanism 800 out of the locked position, ball screw 610 is rotated to move ball nut 620′ to the right (towards head end 110 in the figures). As ball nut 620′ is moved to the right by drive motor assembly 400, 500 and ball screw 610, lock piston stopper 870 forces lock piston 860 to also retract (move to the right) in the process compressing lock spring 830. As lock piston 860 moves in the retracting direction, larger diameter surfaces 866 move out from under lock segments 810 which then ride radially inwardly on ramp surfaces 864 as ball nut 620′ continues rightward movement until lock segments 810 rest on smaller diameter surfaces 862 at which position they are disengaged (fully withdrawn) from receptacles (openings) 202 of barrel 200, and piston 300 is released to move within barrel 200. Ball nut 620′ continues to retract until making contact with ball nut stop 850 whereby ball nut 620′ pulls ball nut stop 850 and piston rod 300 to move in the same retracting direction. Thus, piston 300 is released (unlocked) and able to be moved substantially into barrel 200 to the retracted position.

Drive motor drive 400 and gear assembly 500 preferably include a clutch or other friction plate lock, preferably near the motor end of gear train 520, so that the ball screw assembly 600 tends to remain in the position to which it has been driven by ball screw 610 and motor drive assembly 400, 500 and does not move when drive power is not applied thereto, and alternatively, may be utilized to hold actuator 100 in an intermediate position between the fully extended and fully retracted positions, where it will have a lesser structural load holding capability that may be useful in certain applications.

In the opposite direction, in engaging ball assembly 600 and lock mechanism 800 into the locked position, ball screw 610 is rotated to move ball nut 620′ to the left (towards rod end 120 in the figures). As ball nut 620′ is moved to the left, lock segments 810 are drawn into openings 302 and are adjacent to smaller diameter surfaces 862 at which position they are disengaged (fully withdrawn) from the cavity 202 between barrel 200 and rod end gland fitting 230 as piston rod 300 is extended out of barrel 200. Lock piston 860 is driven in the same direction by ball nut 620′ via force transmitted through lock spring 830.

When ball nut 620′ reaches a position where lock segments 810 are no longer adjacent the interior walls of barrel 200 and are opposite lock segment receptacles 202 thereof, lock segments 810 then are driven radially outwardly on ramp surfaces 664 of lock piston 860 as ball nut 620′ continues leftward movement until lock segments 810 rest on larger diameter surfaces 866 of lock piston 860 at which position they are engaged (driven) into receptacles (openings) 202 of barrel 200, and piston 300 is locked and not able to move axially within barrel 200. Then, piston 300 is structurally fixed with barrel 200 in the extended position, and bears any structural load applied to actuator 100.

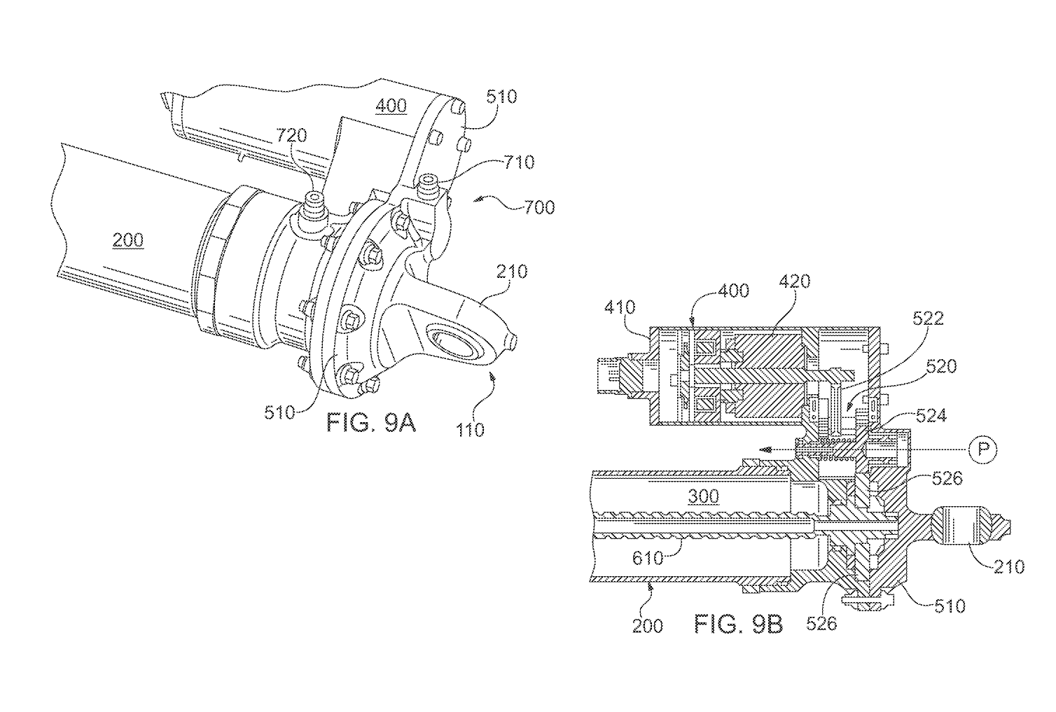

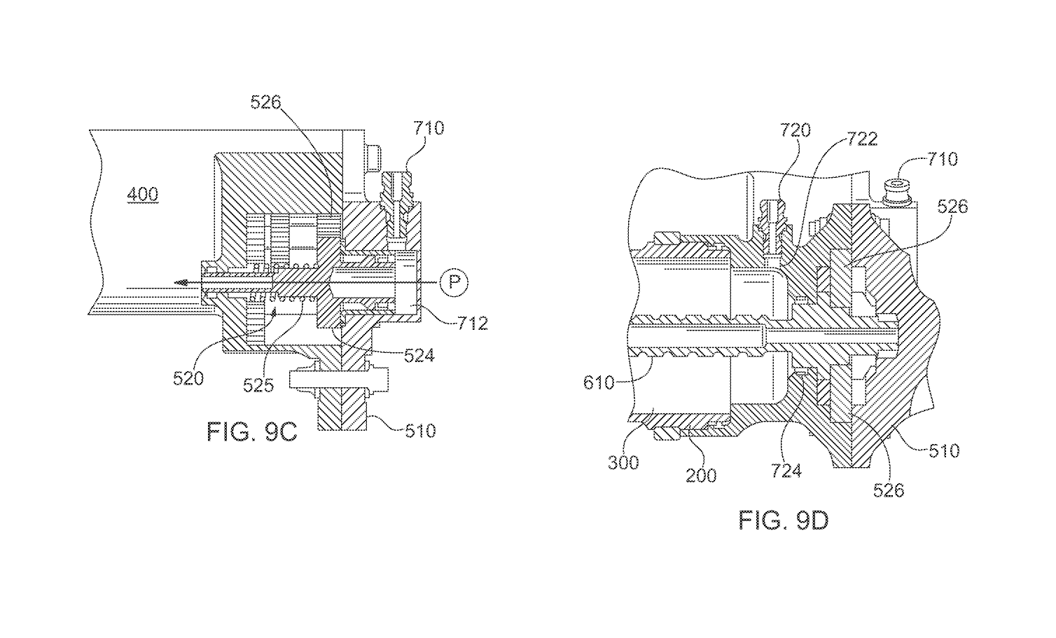

FIG. 9A is a perspective view of the head end 110 of an embodiment of the example actuator 100 including one or more pressure ports 710, 720 therein, and FIGS. 9B-9D are cross-sectional views thereof illustrating operation of the pressure ports 710, 720 to disengage the motor drive 400, 500 and to move the piston rod 300 axially to the extended position. In this embodiment, it is preferred that ball nut 602 is free to “free wheel” on ball screw 610, e.g., when piston rod 300 is moved by pressure applied via ports 710, 720 of “blow down” system 700.

“Blow down” system 700, so called because it permits actuator 100 to be forced to extend by the application of a pressurized fluid thereto, e.g., to lower a landing gear, is an optional feature that may be provided to operate, e.g., extend, actuator 100 when operation by drive motor 400 via gear train 520 and ball screw assembly 600 is not fully operative. The pressurized fluid may be a gas, e.g., compressed air or compressed nitrogen, or a liquid, e.g., hydraulic fluid.

Therein pressurized fluid applied via pressure port 710 is communicated via fluid passage 712 to the side of spur gear 524 of gear train 520 to move spur gear 524 sidewards from its engaged operating position in gear train 520 to a disengaged inoperative position, e.g., to the left as illustrated. The spindle or axle of spur gear 524 preferably extends into and is rotatable in fluid pressure passage 712 so as to serve as a ram or piston for moving spur gear 524 out of gear train 520. As a result, while pressure from pressurized fluid is applied via port 710, gear train 520 no longer provides a geared connection between motor 420 and ball screw 610, and so ball screw 610 is not restrained by the drag or restraining force of motor 420. Spur gear 524 is intermediate the first spur gear 522 which is driven by shaft 422 of motor 420 and final spur gear 526 which drives ball screw 610, and gear train 520 may include additional gears (not umbered) or fewer gears.

Contemporaneously with or after pressure is applied at port 710, but simultaneously therewith so that spur gear 524 is not engaged in gear train 520 while pressure is applied at pressure port 720, pressure applied at port 720 is communicated to the head end of piston rod 300 via fluid passage 722. Because this pressure is confined at the head end of piston rod 300 by one or more seals 724, piston rod 300 may be utilized as a fluid actuated piston or ram. Thus, the pressure applied via pressure port 720 urges piston rod 300 towards its extended position. As piston rod 300 extends out of barrel 200 under the force of such pressure, ball screw 610 and ball nut 620 free wheel so that ball nut 620 moves with piston rod 300 and engages lock mechanism 800, 810, when actuator 100 is fully extended.

Preferably, the applied pressure is selected to be sufficient to drive piston rod 300 to its fully extended position whereat lock mechanism 800 engages, thereby to lock actuator 100 in the fully extended position. A lock indication provided via lock indication ring 820 may be employed to confirm full extension of actuator 100 before pressure is removed from ports 710, 720. Thus, blow down system 700 can operate to extend actuator 100 such that the structural elements of barrel 200, piston rod 300 and lock mechanism 800, 810 bear any applied structural load.

When the pressure at port 710 is removed, spur gear spring 525 urges spur gear 524 back into its engaged operating position in gear train 520, e.g., to the right, and thus motor 420 and ball screw 610 are again connected via engaging gear 524 of gear train 520. Thereafter, actuator 100 may be retracted, e.g., piston rod 300 may be driven into barrel 200, by motor drive assembly 400, gear assembly 500 and ball screw assembly 600, if operative, and actuator may again be extended by motor drive 400 and/or by blow down mechanism 700.

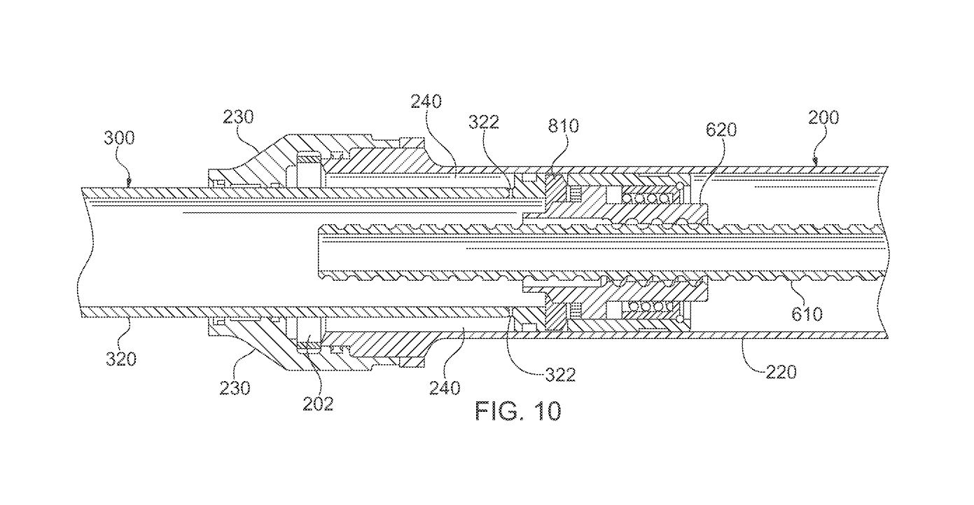

FIG. 10 is a side cross-sectional view of an example embodiment of an actuator 100 including passive damping. To provide passive damping, e.g., hydraulic damping, actuator 100 may be filled with a damping fluid or other damping media, e.g., a hydraulic fluid, in the retracted position when or after it is built. To this end one or more damping orifices 322 are provided in the wall of piston rod tube 320 of piston rod 300 through which the damping fluid can flow under pressure and at a flow limited rate when actuator 100 is extended and/or retracted. Damping fluid or another damping media flows from the interior of piston rod 300 through each orifice 322 into an annular chamber 240 defined between the outer surface of piston rod 300 and the inner surface of barrel 200 when actuator 100 is extending, and flows in the opposite direction when actuator 100 is retracting.

While providing passive fluid damping tends to increase the weight of actuator 100 somewhat, e.g., by the weight of the damping fluid or other damping media, the damping fluid or other damping medium preferably also serves to lubricate the interior elements of actuator 100 whilst providing hydraulic or fluid damping. Fluid damping can be advantageous especially during rapid extension of actuator 100, e.g., with applied pressure aiding extension or with a high pressure load. The damping fluid could be a liquid or a gas.

Where a blow down system 700 is provided along with fluid damping, the amount of blow down fluid needed is reduced because the volume within actuator 100 to be filled thereby is reduced by the volume of the damping fluid. Thus the size and weight of the fluid reservoir for blow down fluid is thereby reduced, and the overall weight for blow down system 700 is similarly reduced by the weight of the damping fluid. Where the damping fluid and the blow down fluid are, e.g., hydraulic fluid, the total weight of actuator 100 is not increased substantially by the passive damping fluid, as the total volume and weight of fluid is about the same with or without passive damping.

“Damping medium” as used herein, e.g., for damping and/or for operation of a blow down system 700, may include, e.g., a hydraulic or other fluid or a gas or another damping medium such as a non-fluid damping medium utilizing self-lubricated powders, viscoelastic media and/or gel media. Suitable non-fluid media, including powders and gels, behave similarly to a fluid in that they “flow” like a liquid through an orifice and thereby provide damping, but they do not present the sealing challenges inherent in preventing the leakage of fluids. Non-fluid media could be used for blow down or in combination with a pneumatic blow down system 700.

In a typical embodiment, barrel 200, gland fitting 230, piston rod 300, housings 410 and 510, ball screw 610 and ball nut 620, and other parts of actuator 100 may be of a steel, e.g., a high strength structural steel, aircraft grade aluminum, titanium or other suitable structural material. The outer surface of piston rod 300 and/or the inner surface of barrel 200 may be hardened or hard coated. Lock segments 810 may be of hardened steel, high strength copper based alloy, spinoidal bronze, beryllium copper (BeCu), aluminum-nickel-bronze (Al—Ni—Br), titanium, or any other suitable hard metal material.

An example embodiment of actuator 100 may have a retracted length of about 21 inches (about 53.3 cm), an extended length of about 31 inches (about 78.7 cm), and a barrel 200 inner diameter of about 2.8 inches (about 7.1 cm), and may weigh about 40 pounds (about 18.2 Kg). Therein, four lock segments may be employed and disposed in a like number of openings in the wall of piston rod 300, and each lock segment may engage one or more recesses, openings or grooves in locking 800 actuator 100. Such example actuator may support a structural load of about 40,000 pounds (about 18,182 Kg) whilst requiring a motor and ball assembly 400, 500, 600 providing an actuating force of about 6000 pounds (6000 pounds equals about 2727 Kg; 6000 pounds-force equals about 26.7 kilo-Newtons).

A screw actuator 100 may comprise: a barrel 200 having a bore and having a lug proximate a head end thereof; a piston rod 300 having a lug proximate a rod end thereof, the piston rod 300 being movable in the bore of the barrel 200 in an extending direction and in a retracting direction; a ball screw 610 rotatably disposed in the bore of the barrel 200, the ball screw 610 being rotatable by the motor drive 400; a motor drive 400 attached to the barrel 200 and configured to rotate the ball screw 610; a ball nut 620 coupled to the ball screw 610 and connected to the piston rod 300, the ball nut 620 being movable in the bore of the barrel 200 in the extending direction and in the retracting direction responsive to rotation of the ball screw 610; and a plurality of lock segments 810 configured in radial openings in the piston rod 300 and movable radially outward and radially inward in response to movement of the ball nut 620, the plurality of lock segments 810 engaging the barrel 200 distal the head end thereof when moved radially outward and not engaging the barrel 200 when moved radially inward, whereby the piston rod 300 is lockable to the barrel 200 by the plurality of lock segments 810 for bearing loads applied thereto. The ball nut 620 has a plurality of surfaces at a relatively smaller radial distance from a central axis adjacent to a plurality of surfaces defining ramp surfaces which are axially adjacent to a plurality of surfaces at a relatively larger radial distance from the central axis for moving the plurality of lock segments 810 radially inwardly and outwardly. The screw actuator 100 wherein the plurality of surfaces at a relatively smaller radial distance from a central axis, the plurality of surfaces at a relatively larger radial distance from the central axis, or both, are segments of a surface or are portions of a surface. The ball nut 620 may include a lock piston 860 having a plurality of surfaces at a relatively smaller radial distance from a central axis axially adjacent to a plurality of surfaces defining ramp surfaces which are axially adjacent to a plurality of surfaces at a relatively larger radial distance from the central axis for moving the plurality of lock segments 810 radially inwardly and outwardly. The screw actuator 100 wherein the plurality of surfaces at a relatively smaller radial distance from a central axis, the plurality of surfaces at a relatively larger radial distance from the central axis, or both, are segments of a surface or are portions of a surface. The motor drive 400 may include: an electric motor and a plurality of gears; or an electric motor, a plurality of gears and a clutch; or a hydraulic motor and a plurality of gears; or a hydraulic motor, a plurality of gears and a clutch. The motor drive 400 may comprise a motor and a gear train, and the actuator 100 may further comprise: first and second pressure ports, the first pressure port being fluidly coupled to the gear train for disengaging at least one gear thereof, and the second pressure port being fluidly coupled to a space between the barrel 200 and the piston rod 300, wherein pressure applied at the first pressure port disengages the motor drive 400 from the ball screw 610, and pressure applied at the second pressure port urges the piston rod 300 in the extending direction. The piston rod 300 may have a bore, and the actuator 100 may further comprise a damping medium in the bore of the barrel 200, in the bore of the piston rod 300, or in both bores, the piston rod 300 having an orifice therein providing a fluid passage between the bore of the barrel 200 and the bore of the piston rod 300, whereby the damping medium passes between the bore of the barrel 200 and the bore of the piston rod 300 as the piston rod 300 is moved in the extending direction and in the retracting direction. The screw actuator 100 may further comprise: a release mechanism, wherein the release mechanism releases the ball screw 610 from the barrel 200 to release the piston rod 300, the ball screw 610 and the ball nut 620 from the barrel 200 and the motor drive 400. The barrel 200 may have a plurality of radial recesses distal the head end thereof and wherein the plurality of lock segments 810 engage the plurality of radial recesses distal the head end of the barrel 200. The barrel 200 may have a plurality of radial recesses and wherein the plurality of lock segments move radially to engage the plurality of radial recesses of the barrel 200, wherein the barrel may include a barrel tube 220, a head end cap 230 at one end of the barrel tube 220 and an end fitting 510 at an opposite end of the barrel tube 200, and wherein the barrel tube 200, the head end cap 230, the end fitting 510, or a combination thereof, define the plurality of radial recesses of the barrel 200.

A screw actuator 100 may comprise: a barrel 200 having a bore; a piston rod 300 movable in the bore of the barrel 200 in an extending direction and in a retracting direction; an elongated screw 610 in the bore of the barrel 200 and rotatable by the motor drive 400; a motor drive 400 attached to the barrel 200 configured to rotate the elongated screw 610; a nut 620 coupled to the elongated screw 610 and connected to the piston rod 300, the nut 620 being movable in the bore of the barrel 200 in the extending direction and in the retracting direction responsive to rotation of the elongated screw 610; and a plurality of lock segments 810 in radial openings in the piston rod 300 and movable radially outward and radially inward in response to movement of the nut 620, the plurality of lock segments 810 engaging the barrel 200 when moved radially outward and not engaging the barrel 200 when moved radially inward, whereby the piston rod 300 is lockable to the barrel 200 by the plurality of lock segments 810 for bearing loads applied thereto. The screw actuator 100 wherein: the elongated screw 610 may include a ball screw 610 and the nut 620 may include a ball nut 620; or the elongated screw 610 may include a screw 610 having an Acme thread and the nut 620 may include a nut 620 having an Acme thread. The barrel 200 may have a plurality of radial recesses distal the head end thereof and wherein the plurality of lock segments 810 engage the plurality of radial recesses distal the head end of the barrel 200. The barrel 200 may have a plurality of radial recesses and wherein the plurality of lock segments move radially to engage the plurality of radial recesses of the barrel 200, wherein the barrel may include a barrel tube 220, a head end cap 230 at one end of the barrel tube 220 and an end fitting 510 at an opposite end of the barrel tube 200, and wherein the barrel tube 200, the head end cap 230, the end fitting 510, or a combination thereof, define the plurality of radial recesses of the barrel 200.

A screw actuator 100 may comprise: a barrel 200 having a bore and having a lug at a head end thereof; a piston rod 300 having a lug at a rod end thereof, the piston rod 300 being movable in the bore of the barrel 200 in an extending direction and in a retracting direction; an elongated screw 610 rotatably disposed in the bore of the barrel 200, the elongated screw 610 being rotatable by the motor drive 400; a motor drive 400 attached to the barrel 200 and configured to rotate the ball screw 610; a nut 620 coupled to the elongated screw 610 and connected to the piston rod 300, the nut 620 being movable in the bore of the barrel 200 in the extending direction and in the retracting direction responsive to rotation of the elongated screw 610; and a plurality of lock segments 810 configured in radial openings in the piston rod 300 and movable radially outward and radially inward in response to movement of the nut 620, the plurality of lock segments 810 engaging the barrel 200 distal the head end thereof when moved radially outward and not engaging the barrel 200 when moved radially inward, whereby the piston rod 300 is lockable to the barrel 200 by the plurality of lock segments 810 for bearing loads applied thereto. The nut 620 may have a plurality of surfaces at a relatively smaller radial distance from a central axis adjacent to a plurality of surfaces defining ramp surfaces which are axially adjacent to a plurality of surfaces at a relatively larger radial distance from the central axis for moving the plurality of lock segments 810 radially inwardly and outwardly. The screw actuator 100 wherein the plurality of surfaces at a relatively smaller radial distance from a central axis, the plurality of surfaces at a relatively larger radial distance from the central axis, or both, are segments of a surface or are portions of a surface. The nut 620 may include a lock piston 860 having a plurality of surfaces at a relatively smaller radial distance from a central axis axially adjacent to a plurality of surfaces defining ramp surfaces which are axially adjacent to a plurality of surfaces at a relatively larger radial distance from the central axis for moving the plurality of lock segments 810 radially inwardly and outwardly. The plurality of surfaces at a relatively smaller radial distance from a central axis, the plurality of surfaces at a relatively larger radial distance from the central axis, or both, are segments of a surface or are portions of a surface. The motor drive 400 may include: an electric motor and a plurality of gears; or an electric motor, a plurality of gears and a clutch; or a hydraulic motor and a plurality of gears; or a hydraulic motor, a plurality of gears and a clutch. The motor drive 400 may comprise a motor and a gear train, the actuator 100 may further comprise: first and second pressure ports, the first pressure port being fluidly coupled to the gear train for disengaging at least one gear thereof, and the second pressure port being fluidly coupled to a space between the barrel 200 and the piston rod 300, wherein pressure applied at the first pressure port disengages the motor drive 400 from the elongated screw 610, and pressure applied at the second pressure port urges the piston rod 300 in the extending direction. The piston rod 300 may have a bore, and the actuator 100 may further comprise a damping medium in the bore of the barrel 200, in the bore of the piston rod 300, or in both bores, the piston rod 300 having an orifice therein providing a fluid passage between the bore of the barrel 200 and the bore of the piston rod 300, whereby the damping medium passes between the bore of the barrel 200 and the bore of the piston rod 300 as the piston rod 300 is moved in the extending direction and in the retracting direction. The screw actuator 100 may further comprise: a release mechanism, wherein the release mechanism releases the elongated screw 610 from the barrel 200 to release the piston rod 300, the elongated screw 610 and the nut 620 from the barrel 200 and the motor drive 400. The elongated screw 610 may include a ball screw 610 and the nut 620 may include a ball nut 620; or the elongated screw 610 may include a screw 610 having an Acme thread and the nut may include a nut 620 having an Acme thread. The barrel 200 may have a plurality of radial recesses distal the head end thereof and wherein the plurality of lock segments 810 engage the plurality of radial recesses distal the head end of the barrel 200. The barrel 200 may have a plurality of radial recesses and wherein the plurality of lock segments move radially to engage the plurality of radial recesses of the barrel 200, wherein the barrel may include a barrel tube 220, a head end cap 230 at one end of the barrel tube 220 and an end fitting 510 at an opposite end of the barrel tube 200, and wherein the barrel tube 200, the head end cap 230, the end fitting 510, or a combination thereof, define the plurality of radial recesses of the barrel 200.

A screw actuator 100 may comprise: a barrel 200 having an elongated bore and having a first lug 210 at a head end thereof, the barrel 200 having a plurality of radial recesses at respective locations distal the head end thereof; a piston rod 300 in the elongated bore of the barrel 200 and having a second lug 310 at a rod end thereof, the piston rod 300 being movable in the elongated bore of the barrel 200 in an extending direction and in a retracting direction; a ball screw 610 rotatably disposed in the elongated bore of the barrel 200, the ball screw 610 being rotatable in the elongated bore of the barrel 200; a motor drive 400 attached to the barrel 200 and configured to rotate the ball screw 610; a ball nut 620 engaging the ball screw 610 and connected to the piston rod 300, the ball nut 620 being movable in the bore of the barrel 200 in the extending direction and in the retracting direction responsive to rotation of the ball screw 610; the ball nut 620 defining a plurality of first surfaces at a relatively smaller radial distance from a central axis adjacent to a plurality of second surfaces defining ramp surfaces which are axially adjacent to a plurality of third surfaces at a relatively larger radial distance from the central axis, whereby the plurality of second surfaces define a plurality of ramp surfaces between the respective first and third surfaces which are at different radial distances from the center line; a plurality of lock segments 810 configured in radial openings in the piston rod 300 to come into contact with the plurality of first, second and third surfaces of the ball nut, the plurality of lock segments bearing against the plurality of first, second and third surfaces for being movable radially outward and radially inward in response to movement of the ball nut 620, the plurality of lock segments 810 engaging the plurality of recesses of the barrel 200 distal the head end thereof when moved radially outward by the plurality of first, second and third surfaces and not engaging the barrel 200 when moved radially inward, whereby the piston rod 300 is lockable to the barrel 200 by the plurality of lock segments 810 engaging the plurality of recesses of the barrel 200 for bearing loads applied thereto via the respective first and second lugs 210, 310. The ball nut 620 may include a lock piston 860 movable axially thereon, wherein the lock piston 860 has a surface defining the plurality of first, second and third surfaces of the ball nut 620 for moving the plurality of lock segments 810 radially inwardly and outwardly. The motor drive 400 may engage the ball screw 610 via a gear train 520, and the screw actuator 100 may further comprise: first and second pressure ports 710, 720, the first pressure port 710 being fluidly coupled to the gear train 520 for disengaging at least one gear 524 thereof, and the second pressure port 720 being fluidly coupled to a space 240 enclosed between the barrel 200 and the piston rod 300, wherein pressure applied at the first pressure port 710 disengages the motor drive 400 from the ball screw 610, and pressure applied at the second pressure port 720 urges the piston rod 300 in the extending direction.

As used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

The term motor drive may be used to refer to the drive motor assembly, the drive motor, the gear assembly, and/or the gear train, and/or any combination thereof, including a direct drive configuration. Further, the terms opening or holes or recesses may be used to refer to particular openings or holes or recesses or to refer to a cavity or space defined in or by one or more parts of actuator 100, e.g., a cavity 202 and/or an opening 302, or to a combination thereof.

The term barrel as used herein includes the various parts that comprise barrel 200, e.g., including barrel tube 220, rod end gland fitting 230 and/or head end cap 510, and may refer to any of such parts individually as well as to the barrel assembly 200. For example, the plural recesses 202 that receive lock segments 810 are in barrel 200, but those plural recesses may physically be formed in or defined by barrel tube 220, by rod end gland fitting 230 and/or by head end cap 510, individually or in combination, depending upon the location or locations at which it is desired that ball nut 620 engage piston rod 300 in a locked relationship with barrel 200, e.g., be that fully extended and/or partially extended, and/or retracted, whereat the loads borne by actuator 100 between end lugs 210, 310 are carried by barrel 200 and piston rod 300, and not by ball screw 610 and ball nut 620.

Although terms such as “up,” “down,” “left,” “right,” “up,” “down,” “front,” “rear,” “side,” “end,” “top,” “bottom,” “forward,” “backward,” “under” and/or “over,” “vertical,” “horizontal,” and the like may be used herein as a convenience in describing one or more embodiments and/or uses of the present arrangement, the articles described may be positioned in any desired orientation and/or may be utilized in any desired position and/or orientation. Such terms of position and/or orientation should be understood as being for convenience only, and not as limiting of the invention as claimed.

While the present invention has been described in terms of the foregoing example embodiments, variations within the scope and spirit of the present invention as defined by the claims following will be apparent to those skilled in the art. For example, drive motor 400 may be employed with a gear train 500 separate therefrom or may have a gear train integral therewith, e.g., in a common housing. Further drive motor 400 may be an electrical motor as described above or may be a motor that is operated by a different form of energy source, e.g., a hydraulic motor.

While the structure at each end of actuator 100 is described as a “lug,” such lug may include a member having an opening, e.g., as illustrated, or may include a threaded member or any other member that may be utilized for attaching actuator to fixed and/or movable structures, and the lugs at the opposite ends of actuator 100 need not be of the same type or kind or size or shape.

While barrel 200 may typically be described as a cylinder barrel, and while piston rod 200 may typically be described as cylindrical, both barrel 200 and piston rod 300 may have may other suitable shape, e.g., may be elliptical or oval. Screw assembly 600 may employ any suitable elongated screw 610 and complementary nut 620, e.g., a screw comprising threaded rod 610 with Acme threads and an Acme thread nut 620, or any other suitable complementary threaded screw and nut.

While certain features may be described as a raised feature, e.g., a ridge, boss, flange, projection or other raised feature, such feature may be positively formed or may be what remains after a recessed feature, e.g., a groove, slot, hole, indentation, recess or other recessed feature, is made. Similarly, while certain features may be described as a recessed feature, e.g., a groove, slot, hole, indentation, recess or other recessed feature, such feature may be positively formed or may be what remains after a raised feature, e.g., a ridge, boss, flange, projection or other raised feature, is made.

Barrel 200 and ball nut 620, 620′ may be configured to engage lock mechanism 800 at the extended position of actuator 100 as described, and may also be configured to engage lock mechanism 800 in a retracted position or in any position intermediate the extended and retracted positions. Lock segments 810 may be provided at different axial locations on ball nut 620, 620′ in such configurations, e.g., near the free end and the head end thereof.

Regarding blow down mechanism 700, an alternative to displacing a spur gear of gear train 520 so as to decouple ball screw assembly 600 from drive motor 420 includes a release mechanism at the head end of ball screw assembly 600 that de-couples that end of ball screw 610 from gear train 520. In one example arrangement, a release mechanism internal to ball screw 610 which couples ball screw 610 to gear train 520, translates axially to release the balls or rollers or other locking mechanism that couple ball screw 610 to gear train 520 so that the balls or rollers move out of contact with ball screw 610 thereby to free ball screw 610, and therefore free piston rod 300, from barrel 200. As a result, the complete ball screw assembly moves with piston rod 300 thereby allowing piston rod to be moved, e.g., by hydraulic or pneumatic pressure, even if ball screw assembly 600 were to become jammed.

Each of the U.S. Provisional applications, U.S. patent applications, and/or U.S. patents, identified herein is hereby incorporated herein by reference in its entirety, for any purpose and for all purposes irrespective of how it may be referred to or described herein.

Finally, numerical values stated are typical or example values, are not limiting values, and do not preclude substantially larger and/or substantially smaller values. Values in any given embodiment may be substantially larger and/or may be substantially smaller than the example or typical values stated.

What is claimed is:

1. A screw actuator comprising:
a barrel having a bore and having a lug proximate a head end thereof;
a piston rod having a lug proximate a rod end thereof, said piston rod being movable in the bore of said barrel in an extending direction and in a retracting direction;
a ball screw rotatably disposed in the bore of said barrel, said ball screw being rotatable by said motor drive;
a motor drive attached to said barrel and configured to rotate said ball screw;
a ball nut coupled to said ball screw and connected to said piston rod, said ball nut being movable in the bore of said barrel in the extending direction and in the retracting direction responsive to rotation of said ball screw; and
a plurality of lock segments configured in radial openings in said piston rod and movable radially outward and radially inward in response to movement of said ball nut,
said plurality of lock segments engaging said barrel distal the head end thereof when moved radially outward and not engaging said barrel when moved radially inward,
whereby said piston rod is lockable to said barrel by said plurality of lock segments engaging said barrel for bearing loads applied thereto via the respective lugs.

2. The screw actuator of claim 1 wherein said ball nut has a plurality of surfaces at a relatively smaller radial distance from a central axis adjacent to a plurality of surfaces defining ramp surfaces which are axially adjacent to a plurality of surfaces at a relatively larger radial distance from the central axis for moving said plurality of lock segments radially inwardly and outwardly.

3. The screw actuator of claim 2 wherein the plurality of surfaces at a relatively smaller radial distance from a central axis, the plurality of surfaces at a relatively larger radial distance from the central axis, or both, are segments of a surface or are portions of a surface.

4. The screw actuator of claim 1 wherein said ball nut includes a lock piston having a plurality of surfaces at a relatively smaller radial distance from a central axis axially adjacent to a plurality of surfaces defining ramp surfaces which are axially adjacent to a plurality of surfaces at a relatively larger radial distance from the central axis for moving said plurality of lock segments radially inwardly and outwardly.

5. The screw actuator of claim 4 wherein the plurality of surfaces at a relatively smaller radial distance from a central axis, the plurality of surfaces at a relatively larger radial distance from the central axis, or both, are segments of a surface or are portions of a surface.

6. The screw actuator of claim 1 wherein said motor drive includes:
an electric motor and a plurality of gears; or
an electric motor, a plurality of gears and a clutch; or
a hydraulic motor and a plurality of gears; or
a hydraulic motor, a plurality of gears and a clutch.

7. The screw actuator of claim 1 wherein said motor drive comprises a motor and a gear train, said screw actuator further comprising:
first and second pressure ports, the first pressure port being fluidly coupled to said gear train for disengaging at least one gear thereof, and the second pressure port being fluidly coupled to a space between said barrel and said piston rod,
wherein pressure applied at said first pressure port disengages said motor drive from said ball screw, and pressure applied at said second pressure port urges said piston rod in the extending direction.

8. The screw actuator of claim 1 wherein said piston rod has a bore, said screw actuator further comprising a damping medium in the bore of said barrel, in the bore of said piston rod, or in both bores, said piston rod having an orifice therein providing a fluid passage between the bore of said barrel and the bore of said piston rod, whereby the damping medium passes between the bore of said barrel and the bore of said piston rod as said piston rod is moved in the extending direction and in the retracting direction.

9. The screw actuator of claim 1 wherein said barrel has a plurality of radial recesses distal the head end thereof and wherein said plurality of lock segments engage the plurality of radial recesses distal the head end of said barrel.

10. The screw actuator of claim 1:
wherein said barrel has a plurality of radial recesses and wherein said plurality of lock segments move radially to engage the plurality of radial recesses of said barrel,
wherein said barrel includes a barrel tube, a head end cap at one end of the barrel tube and an end fitting at an opposite end of said barrel tube, and
wherein the barrel tube, the head end cap, the end fitting, or a combination thereof, define the plurality of radial recesses of said barrel.

11. A screw actuator comprising:
a barrel having a bore;
a piston rod movable in the bore of said barrel in an extending direction and in a retracting direction;
an elongated screw in the bore of said barrel and rotatable therein;
a motor drive configured to rotate said elongated screw;
a nut coupled to said elongated screw and connected to said piston rod, said nut being movable in the bore of said barrel in the extending direction and in the retracting direction responsive to rotation of said elongated screw; and
a plurality of lock segments in radial openings in said piston rod and movable radially outward and radially inward in response to movement of said nut,
said plurality of lock segments engaging said barrel when moved radially outward and not engaging said barrel when moved radially inward,
whereby said piston rod is lockable to said barrel by said plurality of lock segments for bearing loads applied thereto.

12. The screw actuator of claim 11:
wherein said barrel has a plurality of radial recesses and wherein said plurality of lock segments move radially to engage the plurality of radial recesses of said barrel,
wherein said barrel includes a barrel tube, a head end cap at one end of the barrel tube and an end fitting at an opposite end of said barrel tube, and
wherein the barrel tube, the head end cap, the end fitting, or a combination thereof, define the plurality of radial recesses of said barrel.

13. The screw actuator of claim 11 wherein:
said elongated screw includes a ball screw and said nut includes a ball nut; or
said elongated screw includes a screw having an Acme thread and said nut includes a nut having an Acme thread.

14. A screw actuator comprising:
a barrel having a bore and having a lug proximate a head end thereof;
a piston rod having a lug proximate a rod end thereof, said piston rod being movable in the bore of said barrel in an extending direction and in a retracting direction;
an elongated screw rotatably disposed in the bore of said barrel;
a motor drive attached to said barrel and configured to rotate said elongated screw;
a nut coupled to said elongated screw and connected to said piston rod, said nut being movable in the bore of said barrel in the extending direction and in the retracting direction responsive to rotation of said elongated screw; and
a plurality of lock segments configured in radial openings in said piston rod and movable radially outward and radially inward in response to movement of said nut,
said plurality of lock segments engaging said barrel when moved radially outward and not engaging said barrel when moved radially inward,
whereby said piston rod is lockable to said barrel by said plurality of lock segments for bearing loads applied thereto.

15. The screw actuator of claim 14 wherein said nut has a plurality of surfaces at a relatively smaller radial distance from a central axis adjacent to a plurality of surfaces defining ramp surfaces which are axially adjacent to a plurality of surfaces at a relatively larger radial distance from the central axis for moving said plurality of lock segments radially inwardly and outwardly.

16. The screw actuator of claim 15 wherein the plurality of surfaces at a relatively smaller radial distance from a central axis, the plurality of surfaces at a relatively larger radial distance from the central axis, or both, are segments of a surface or are portions of a surface.

17. The screw actuator of claim 14 wherein said nut includes a lock piston having a plurality of surfaces at a relatively smaller radial distance from a central axis axially adjacent to a plurality of surfaces defining ramp surfaces which are axially adjacent to a plurality of surfaces at a relatively larger radial distance from the central axis for moving said plurality of lock segments radially inwardly and outwardly.

18. The screw actuator of claim 17 wherein the plurality of surfaces at a relatively smaller radial distance from a central axis, the plurality of surfaces at a relatively larger radial distance from the central axis, or both, are segments of a surface or are portions of a surface.

19. The screw actuator of claim 14 wherein said motor drive includes:
an electric motor and a plurality of gears; or
an electric motor, a plurality of gears and a clutch; or
a hydraulic motor and a plurality of gears; or
a hydraulic motor, a plurality of gears and a clutch.

20. The screw actuator of claim 14 wherein said motor drive comprises a motor and a gear train, said screw actuator further comprising:
first and second pressure ports, the first pressure port being fluidly coupled to said gear train for disengaging at least one gear thereof, and the second pressure port being fluidly coupled to a space between said barrel and said piston rod,
wherein pressure applied at said first pressure port disengages said motor drive from said elongated screw, and pressure applied at said second pressure port urges said piston rod in the extending direction.

21. The screw actuator of claim 14 wherein said piston rod has a bore, said screw actuator further comprising a damping medium in the bore of said barrel, in the bore of said piston rod, or in both bores, said piston rod having an orifice therein providing a fluid passage between the bore of said barrel and the bore of said piston rod, whereby the damping medium passes between the bore of said barrel and the bore of said piston rod as said piston rod is moved in the extending direction and in the retracting direction.

22. The screw actuator of claim 14 wherein said barrel has a plurality of radial recesses distal the head end thereof and wherein said plurality of lock segments engage the plurality of radial recesses distal the head end of said barrel.

23. The screw actuator of claim 14:
wherein said barrel has a plurality of radial recesses and wherein said plurality of lock segments move radially to engage the plurality of radial recesses of said barrel,
wherein said barrel includes a barrel tube, a head end cap at one end of the barrel tube and an end fitting at an opposite end of said barrel tube, and
wherein the barrel tube, the head end cap, the end fitting, or a combination thereof, define the plurality of radial recesses of said barrel.

24. The screw actuator of claim 14 wherein:
said elongated screw includes a ball screw and said nut includes a ball nut; or
said elongated screw includes a screw having an Acme thread and said nut includes a nut having an Acme thread.

25. A screw actuator comprising:
a barrel having an elongated bore and having a first lug at a head end thereof, said barrel having a plurality of radial recesses at respective locations distal the head end thereof;
a piston rod in the elongated bore of said barrel and having a second lug at a rod end thereof, said piston rod being movable in the elongated bore of said barrel in an extending direction and in a retracting direction;
a ball screw rotatably disposed in the elongated bore of said barrel, said ball screw being rotatable in the elongated bore of said barrel;
a motor drive attached to said barrel and configured to rotate said ball screw;
a ball nut engaging said ball screw and connected to said piston rod, said ball nut being movable in the bore of said barrel in the extending direction and in the retracting direction responsive to rotation of said ball screw;
said ball nut defining a plurality of first surfaces at a relatively smaller radial distance from a central axis adjacent to a plurality of second surfaces defining ramp surfaces which are axially adjacent to a plurality of third surfaces at a relatively larger radial distance from the central axis, whereby the plurality of second surfaces define a plurality of ramp surfaces between the respective first and third surfaces which are at different radial distances from the center line;
a plurality of lock segments configured in radial openings in said piston rod to come into contact with the plurality of first, second and third surfaces of said ball nut, said plurality of lock segments bearing against said plurality of first, second and third surfaces for being movable radially outward and radially inward in response to movement of said ball nut,
said plurality of lock segments engaging the plurality of recesses of said barrel distal the head end thereof when moved radially outward by the plurality of first, second and third surfaces and not engaging said barrel when moved radially inward,
whereby said piston rod is lockable to said barrel by said plurality of lock segments engaging the plurality of recesses of said barrel for bearing loads applied thereto via the respective first and second lugs.

26. The screw actuator of claim 25 wherein said ball nut includes a lock piston movable axially thereon, wherein said lock piston has a surface defining the plurality of first, second and third surfaces of said ball nut for moving said plurality of lock segments radially inwardly and outwardly.

27. The screw actuator of claim 25 wherein said motor drive engages said ball screw via a gear train, said screw actuator further comprising:
first and second pressure ports, the first pressure port being fluidly coupled to said gear train for disengaging at least one gear thereof, and the second pressure port being fluidly coupled to a space enclosed between said barrel and said piston rod,
wherein pressure applied at said first pressure port disengages said motor drive from said ball screw, and pressure applied at said second pressure port urges said piston rod in the extending direction.
